(19) United States
(12) Patent Application Publication
(10) Pub. No.: US 2007/0247995 A1
(43) Pub. Date: Oct. 25, 2007

(54) COMPATIBLE OPTICAL PICKUP HAVING HIGH EFFICIENCY AND OPTICAL RECORDING AND/OR REPRODUCING APPARATUS INCLUDING THE SAME

(75) Inventors: Kyong-tae Park, Yongin-si (KR); Tae-kyung Kim, Seoul (KR); Woo-seok Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co.,Ltd., Suwon-si (KR)

(21) Appl. No.: 11/618,157

(22) Filed: Dec. 29, 2006

(30) Foreign Application Priority Data
Apr. 20, 2006 (KR) 2006-35771

(51) Int. Cl. G11B 7/135

(52) U.S. Cl. 369/112.1

(57) ABSTRACT

An optical pickup that is compatibly utilized having a high optical efficiency and an optical recording and/or reproducing apparatus including the optical pickup includes a light source, a polarization beam splitter to transmit or to reflect an incident light beam according to a polarization direction of the incident light beam, a quarter wave plate to change the polarization direction of the light beam that passes through the polarization beam splitter, a holographic optical element formed of an anisotropic material and including a diffraction pattern to transmit or to diverge the light beam that passes through the quarter wave plate according to the polarization direction of the beam, and an objective lens to focus a first polarized beam component that is transmitted directly through the holographic optical element onto the first information storage medium with a first numerical aperture (NA), and to focus a second polarized beam that is diverged by the holographic optical element onto the second information storage medium with a second NA.

### CROSS-REFERENCE TO RELATED APPLICATIONS

This application claims the benefit of Korean Application No. 2006-35771, filed Apr. 20, 2006, in the Korean Intellectual Property Office, the disclosure of which is incorporated herein by reference.

### BACKGROUND OF THE INVENTION

1. Field of the Invention

Aspects of the present invention relate to an optical pickup having a high efficiency and an optical recording and/or reproducing apparatus including the optical pickup, and more particularly, an optical pickup that can be compatibly used in different kinds of information storage media using an objective lens with high efficiency, and an optical recording and/or reproducing apparatus.

2. Description of the Related Art

In an optical recording and/or reproducing apparatus which records information on an information storage medium, for example, an optical disk, or which reproduces recorded information using an optical spot focused by an objective lens, a recording capacity is determined by the size of the optical spot. In order to increase recording capacity, the size of the optical spot should be decreased. A diameter (S) of the optical spot is determined by the wavelength (λ) of the light and numerical aperture (NA) of the objective lens as per the following equation 1.

S∝λ/NA (1)

Therefore, in order to increase recording capacity, the size of the optical spot that is focused on the optical disk should be reduced by decreasing a wavelength of an optical beam, and/or increasing the NA of the objective lens.

Recently, a Blu-ray disk (BD) standard of about 25 GB of capacity has been suggested. The BD standard uses a light source having a wavelength around 405 nm, an objective lens having an NA of 0.85, and an optical disk having a thickness of 0.1 mm. The thickness of the optical disk is the distance measured from a surface of the optical disc where light is incident to a surface of the optical disc where information is recorded, and corresponds to the thickness of a protective layer.

Also, a high-definition DVD (HD DVD) having a capacity of 15 GB has been suggested. The HD DVD standard uses the same wavelength as that of the BD standard, (i.e., about 405 nm), an objective lens having an NA of 0.65, and an optical disk having a thickness of 0.6 mm. The thickness of the optical disc is the distance measured from a surface of the optical disc where light is incident to a surface where information is recorded, and corresponds to the thickness of a substrate.

There is a need to use information storing media having different standards, such as the BD and HD DVD, together in the same optical system. This system needs to compatibly use information storing media having different standards.

In the case of the DVD (for example, a DVD-RAM and a DVD±RW), both the DVD-RAM and the DVD±RW have nearly the same wavelengths, NAs of objective lenses, and thicknesses of the optical disk substrates. In contrast, the DVD-RAM and DVD±RW have different track pitches and structures. Therefore, the focusing of the optical beam emitted from the light source onto the optical disk using the objective lens is the same in both the DVD-RAM and DVD±RW, regardless of the standard of the optical disk, and thus, the compatibility of the focusing and tracking operations according to the track pitch must be considered.

However, in the case where the next generation information storing media standards (for example, the BD and the HD DVD), are used together in the same system, the different thicknesses of the optical discs generate a large spherical aberration. This spherical aberration must be compensated for. In order to compensate for the spherical aberration caused by the thickness difference between the different information storing media which use a light source, a holographic optical element or two objective lenses is conventionally used.

In an optical system using two objective lenses, the number of optical elements is large, thereby increasing fabricating costs. In addition, it is difficult to adjust an optical axis with respect to the two objective lenses. Therefore, a method of reducing the spherical aberration using one objective lens and the holographic optical element is suggested as follows.

Japanese Laid-open Patent No. hei 08-062493 discloses a method of compatibly using a compact disc with a light source for the DVD using a holographic optical element. FIG. 1 illustrates an optical pickup disclosed in the above invention. An optical beam is focused using one objective lens 4 with respect to a first information medium 37 having a first thickness t1 and a second information medium 51 having a second thickness t2. The optical beam is focused at a focal point 38a. The optical beam emitted from one light source is diffracted by the holographic optical element 107. The holographic optical element 107 includes a substrate 9, a hologram pattern area 107a and a non-hologram pattern area 107b. 0th order beams 61 are focused on the second information medium 51 and a 1st order beam 64 is focused on the first information medium 37. However, according to the conventional optical pickup, when the optical beams 3 that are emitted from the same light source are separated by the holographic optical element 107, there is a limitation in that an optical efficiency is prevented from increasing due to a limitation in diffraction efficiency. The reasons why the diffraction efficiency prevents the optical efficiency from increasing will be described in more detail as follows.

FIG. 2 illustrates the diffraction efficiency of the holographic optical element 107 according to an order of diffraction. As shown in FIG. 2, the holographic optical element 107 is designed so that both the 0th order beam and the 1st order beam have a higher diffraction efficiency than the 2nd order beam. The holographic optical element 107 can be designed to have a higher diffraction efficiency for either the 0th beam 61 or the 1 st order beam 64. The optical beam 3 that is incident on the objective lens 4 is made of beams which radiate parallel to each other and are incident to the objective lens as non-diverged beams. The incident beam 3 records information onto or reproduces recorded information from the second information medium 51, which is thinner than the first information medium 37. Meanwhile, the 1st order beam 64 is diverged to record information on or reproduce recorded information from the first information medium 37, which is thicker than the second information medium 51. The holographic optical element 107 is a blazed diffraction device formed in a stair shape of four stages, and the efficiency of each diffraction order is controlled according to a depth of a grating interval.

Referring to FIG. 2, FIG. 2 illustrates a case where either the 0th order beam 61 (as shown in FIG. 1) or the 1st order beam 64 (as shown in FIG. 1) has a higher diffraction efficiency than the other beam. For example, as shown in FIG. 2, when the diffraction efficiency of the 0th order beam 61a is 60%, the diffraction efficiency of the 1st order beam 64 is about 25%. Therefore, when it is assumed that the intensity of the incident light is 100, the intensity of the 0th order beam 61 reciprocating through the holographic optical element 107 is 0.6×0.6×100=36, and the intensity of the 1st order beam 64 reciprocating through the holographic optical element 107 is 0.25×0.25×100=6.25. As described above and as shown in FIG. 2, when the intensity of the 0th order beam 61 increases, the intensity of the 1 st order beam 64 greatly decreases. Additionally, if the difference between the intensities of the 0th order beam 61 and the 1 st order beam 64 increases, the 0th order beam 61 interferes with the optical spot of the 1st order beam 64. Therefore, there must not be a large difference between the diffraction efficiencies of the 0th order beam 61 and the 1st order beam 64 in order to obtain signal quality suitable for two different kinds of information storing media.

However, the diffraction efficiencies of the 0th order beam 61 and the 1st order beam 64 are the same at a point denoted as “A” in FIG. 2, where the diffraction efficiency of both the 0th order beam 61 and the 1st order beam 64 is 40%. In this case, 20% of light is lost, In addition, when the 0th order beam 61 and the 1st order beam 64 both reciprocate through the holographic optical element 107, the intensity of the output light is 0.4×0.4×100=16 when the intensity of the incident light is 100. Therefore, if the diffraction efficiencies of the 0th order beam 61 and the 1 st order beam 64 are set to be the same, the maximum diffraction efficiencies of the 0th order beam 61 and the 1st order beam 64 are just 40%. Thus, there is a limitation in how much the optical efficiency can be increased in the conventional art.

### SUMMARY OF THE INVENTION

Aspects of the present invention provide an optical pickup that can be compatibly used with different kinds of information storing media which use a light source and an objective lens and obtains a high optical efficiency, and an optical recording and/or reproducing apparatus using the optical pickup.

Additional aspects and/or advantages of the invention will be set forth in part in the description which follows and, in part, will be obvious from the description, or may be learned by practice of the invention.

According to an aspect of the present invention, an optical pickup that is compatibly used with respect to a first information storage medium and a second information storage medium having different standards includes a light source, a polarization beam splitter to transmit or reflect an incident light beam according to a polarization direction of the incident light, a quarter wave plate to change the polarization direction of the light beam that passes through the polarization beam splitter a holographic optical element formed of an anisotropic material and including a diffraction pattern to directly transmit or diverge the light beam that passes through the quarter wave plate according to the polarization direction of the light beam, and an objective lens to focus a first polarized beam component that is transmitted directly through the holographic optical element onto the first information storage medium with a first numerical aperture (NA), and to focus a second polarized beam component that is diverged by the holographic optical element onto the second information storage medium with a second NA.

According to an aspect of the invention, the second polarized beam component may be diffracted as a +1st order beam.

According to an aspect of the invention, the holographic optical element may have a blazed type holographic pattern.

According to an aspect of the invention, the optical pickup may further include a collimating lens disposed between the light source and the polarization beam splitter.

According to another aspect of the present invention an optical recording and/or reproducing apparatus includes an optical pickup to compatibly operate with a first information storage medium and a second information storage medium that have different standards, a driving unit to drive the optical pickup, and a controller to control the optical pickup, wherein the optical pickup includes a light source, a polarization beam splitter to transmit or reflect an incident light beam according to a polarization direction of the incident light, a quarter wave plate to change the polarization direction of the light beam that passes through the polarization beam splitter, a holographic optical element formed of an anisotropic material and including a diffraction pattern to directly transmit or diverge the light beam that passes through the quarter wave plate according to the polarization direction of the light beam, and an objective lens to focus a first polarized beam component that is transmitted directly through the holographic optical element onto the first information storage medium with a first numerical aperture (NA), and to focus a second polarized beam component that is diverged by the holographic optical element onto the second information storage medium with a second NA.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view illustrating an optical pickup disclosed in Japanese Laid-open Patent No. 08-062493;

FIG. 2 is a graph illustrating diffraction efficiencies according to an order of diffraction of a holographic optical element in the optical pickup illustrated in FIG. 1;

FIG. 3A is a cross-sectional view illustrating an optical pickup applied to a first information storage medium according to an embodiment of the present invention;

FIG. 3B is a cross-sectional view of the optical pickup illustrated in FIG. 3A applied to a second information storage medium, according to an embodiment of the present invention;

FIG. 4A illustrates a focusing error signal of the first information storage medium detected when the optical pickup illustrated in FIG. 3A determines the kind of information storage medium being used;

FIG. 4B illustrates a focusing error signal of the second information storage medium detected when the optical pickup of FIG. 3A determines the kind of information storage medium being used;

FIG. 5 is a flowchart illustrating a method of determining the kind of information storage medium being used by the optical pickup according to an embodiment of the present invention; and

FIG. 6 is a schematic block diagram of an optical recording and/or reproducing apparatus including an optical pickup, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An optical pickup 200 according to an embodiment of the present invention can be compatibly applied to a first information storage medium and a second information storage medium of different standards using a light source and an objective lens. The first and second information storing media can have different physical conditions, such as different track pitches and/or different thicknesses. According to the different physical conditions, information capacities of the first and second information storing media may be different from each other. For example, in a case where the thicknesses of the first and second information storing media are different, a spherical aberration caused by the difference in thicknesses and the difference in working distances when the light is focused using one objective lens must be compensated for.

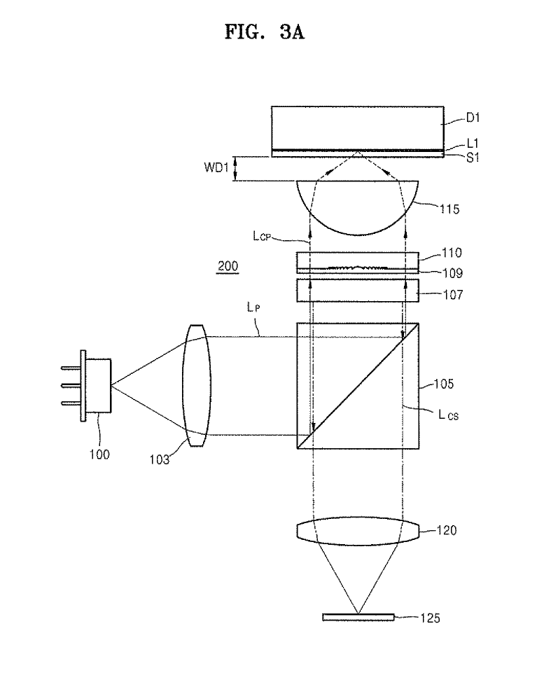

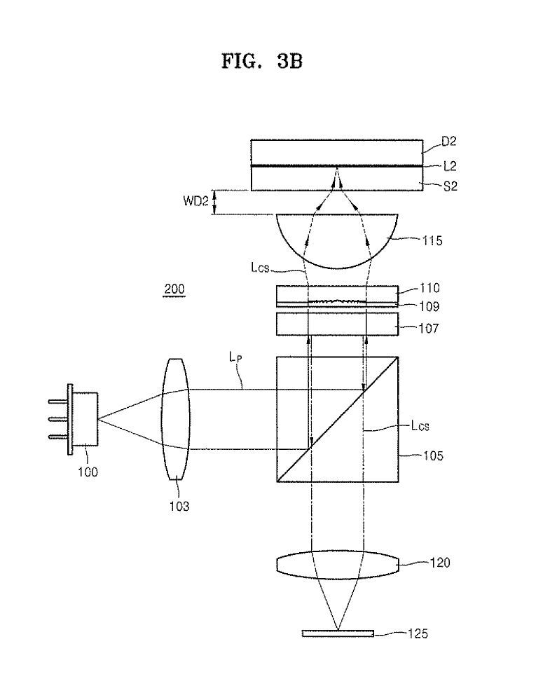

FIG. 3A illustrates the optical pickup 200 applied to a first information storage medium D1, and FIG. 3B illustrates the optical pickup 200 applied to a second information storage medium D2, according to embodiments of the present invention. The optical pickup 200 includes a light source 100 to irradiate a beam of a predetermined wavelength, a quarter wave plate 107 to change a polarization direction of the beam into a circular polarization, a holographic optical element 110 whose diffraction property changes according to the polarization direction of the incident beam, and a photodetector 125 to detect beams reflected by the first and second information storing media D1 and D2.

The holographic optical element 110 is preferably, but not necessarily, formed of an anisotropic material having a refractive index that changes according to the polarization direction of the incident beam. The holographic optical element 110 thus transmits a first polarized beam in a straight direction, and diffracts a second polarized beam. PolyEthyleneTerephthalate (PET), PolyButyleneTerephthalate (PBT), or PolyEthyleneNaphthalate (PEN) may be used as the anisotropic material, although it is understood that other materials may also be used as the anisotropic material. Holographic patterns are formed on an upper surface or a lower surface of the holographic optical element 110. A plate 109 formed of a light transmitting material preferably, but not necessarily, has the same refractive index as that of the holographic optical element 110 with respect to the first polarized beam, and preferably, but not necessarily, is disposed on the lower surface of the holographic optical element 110 to be between the holographic optical element 110 and the plate 107. The first and second polarized beams are respectively focused on the first and second information storing media D1 and D2 through the objective lens 115. The objective lens 115 focuses the first polarized beam with a first numerical aperture (NA), and focuses the second polarized beam with a second NA.

A collimating lens 103 focuses the beams emitted from the light source 100 in directions parallel or substantially parallel to each other. A polarization beam splitter 105 transmits or reflects the incident light according to the polarization direction of the beam. As shown in FIGS. 3A and 3B, the collimating lens 103 and the polarization beam splitter 105 may be disposed between the light source 100 and the quarter wave plate 107, with the collimating lens 103 disposed next to the light source 100. However, the collimating lens 103 may be disposed in a different configuration. For example, the collimating lens 103 may be disposed between the polarization beam splitter 105 and the quarter wave plate 107, instead of between the light source 100 and the polarization beam splitter 105. Additionally, components other than the polarization beam splitter 105 and the quarter wave plate 107 may be used to polarize the light beams and/or to change a direction of light passing between the light source 100, the objective lens 115, and the photodetector 125. Further, if the light source 100 and the photodetector 125 are collocated, it is understood that the splitter 105 need not be used or located as shown.

The operations in the cases where the optical pickup 200 is applied to the first and second information storing media D1 and D2 will be described as follows. Straight polarized beams Lp of a short wavelength are divergently irradiated from the light source 100. Then, these divergent beams become parallel to each other through the collimating lens 103. The straight polarized beams Lp are reflected by the polarization beam splitter 105 and are incident onto the quarter wave plate 107. The straight polarized beams Lp are converted into circular-polarized beams while passing through the quarter wave plate 107, and are then incident to the holographic optical element 110 after passing through the plate 109.

The circular-polarized beams include a first polarization beam component Lcp and a second polarization beam component Lcs. Since the holographic optical element 110 has the same refractive index as that of the plate 109, the first polarization beam component Lcp is transmitted directly through the holographic optical element 110. However the second polarization beam component Lcs is diffracted by the holographic optical element 110. In other words, the first polarization beam component Lcp is transmitted directly through the holographic optical element 110 and does not diverge, while the second polarization beam component Lcs can be a +1st order beam or a −1st order beam which does diverge. The holographic optical element 110 uses the order of diffraction in order to maximize the diffraction efficiency, and has a blazed type holographic pattern so that the diffraction efficiency can be a maximum for the order of diffraction. In addition, the holographic optical element 110 is preferably fabricated as a passive element in order to reduce fabrication costs, and the diffraction efficiency can be controlled by adjusting the depths and the intervals of the blazed type holographic pattern. However, it is understood that the holographic optical element 110 does not have to be a passive element.

The first polarization beam component Lcp is focused on the first information storage medium D1 by the objective lens 115 as the first optical spots having the first NA. In addition, the second polarization beam component Lcs is focused on the second information storage medium D2 as the second optical spots having the second NA. In other words, the first optical spot formed by the first polarization beam component Lcp and the second optical spot formed by the second polarization beam component Lcs have different focal distances. As described above, since the first and second polarization beam components Lcp and Lcs focus on the corresponding information storing media with appropriate focal distances, respectively, the optical pickup according to an aspect of the invention compensates for the spherical aberration generated due to the thickness difference between the information storing media.

The first and second information storing media D1 and D2 respectively have different thicknesses s1 and s2, and different working distances WD1 and WD2. For example, the first information storage medium D1 may be a Blu-ray disc (BD) which uses a light source having a wavelength about 405 nm, an objective lens having an NA of 0.85, and has a thickness s1 of 0.1 mm. The thickness s1 corresponds to the thickness measured from the surface where light is incident on the first information storage medium D1 to the information recording layer L1 that is, the thickness of the protective layer, and can have a capacity of about 25 GB. The second information storage medium D2 may be a high definition DVD (HD DVD) which uses a light source having the same wavelength as that of the first information storage medium D1, an objective lens having an NA of 0.65, and a thickness s2 of 0.6 mm. The thickness s2 is a distance measured from the surface where light is incident on the second information storage medium D2 to the information recording layer L2 (that is, the thickness of a substrate), and can have a capacity of about 15 GB.

The first and second information storing media D1 and D2 are not limited to being a BD and an HD DVD. Alternatively, the first information storage medium D1 may be, for example, a DVD, and the second information storage medium D2 may be, for example, a CD. The optical pickup according to aspects of the present invention can be compatibly applied to many different kinds of information storing media having different thicknesses and different standards.

The first polarization beam component Lcp that is reflected from the first information storage medium D1 is incident on the quarter wave plate 107 after passing through the objective lens 115 and the holographic optical element 110. The quarter wave plate 107 changes the first polarization beam component Lcp into a circular-polarized beam having another first polarized beam component Lcp and another second polarized beam component Lcs. The another first polarized beam component Lcp is then reflected by the polarization beam splitter 105. The another second polarized beam component Lcs is transmitted through the polarization beam splitter 105 and is focused on the photo detector 125 by a lens 120. The lens 120 is preferably, but not necessarily, disposed between the polarization beam splitter 105 and the photo detector 125 in order to focus the beam reflected from the information storing media onto the photo detector 125.

The second polarization beam component Lcs that is reflected by the second information storage medium D2 is incident on the quarter wave plate 107 after passing through the objective lens 115 and the holographic optical element 110. The quarter wave plate 107 changes the second polarization beam component Lcs into a circular-polarized beam by the quarter wave plate 107 to produce another first polarized beam component Lcp and another second polarized beam component Lcs. The another second polarized beam component Lcs is then reflected by the polarization beam splitter 105, and the another second polarization beam component Lcs is transmitted through the polarization beam splitter 105 and is focused on the photo detector 125 by the lens 120.

The optical efficiency of the optical pickup 200 according to aspects of the present invention will be described as follows. When the intensity of the light irradiated from the light source 100 is assumed to be 100, the light intensity of the first polarization beam component Lcp which is focused on the first information storage medium D1 is reduced by 50% when the beam passes through the holographic optical element 110, and is reduced by 50% again when the beam passes through the polarization beam splitter 105 after being reflected by the first information storage medium D1. Therefore, when the intensity of the light irradiated from the light source 100 is assumed to be 100, the intensity of the first polarization beam component Lcp detected by the photo detector 125 is 100×0.5×0.5=25.

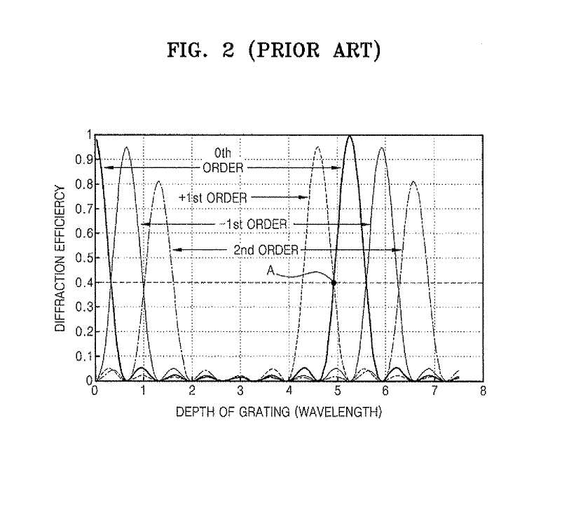

Additionally, referring to FIG. 2, the maximum diffraction efficiency of a single order diffraction beam (+1st order diffraction beam or −1st order diffraction beam) is 95%. Therefore, if it is assumed that the intensity of the light irradiated from the light source 100 is assumed to be 100, and if it is further assumed that the single order diffraction beam having the maximum diffraction efficiency of 95% due to the holographic optical element 110 is used for the second information storage medium D2, the intensity of the second polarization beam component Lcs which is focused on the second information storage medium D2 is reduced by 47.5% (0.5×0.95×100) when the beam passes through the holographic optical element 110, and is again reduced by 47.5% (0.5×0.95×100) when the beam passes through the holographic optical device 110 and the polarization beam splitter 105 after being reflected by the second information storage medium D2. Consequently, the intensity of the second polarization beam component Lcs that is detected by the photo detector 125 is 100×0.475×0.475=22.56. Since the intensity of the first polarization beam component Lcp that is used for the first information storage medium D1 and the intensity of the second polarization beam component Lcs that is used for the second information storage medium D2 are similar to each other, the beam component having a relatively higher intensity hardly affects the beam component having a relatively lower intensity. Therefore, the data recording/reproducing operations for both the first and second information storing media D1 and D2 are performed in a very stable fashion.

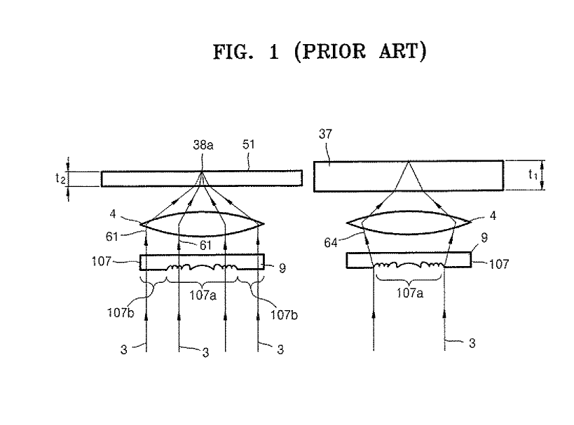

In addition, since the light beam emitted from the light source 100 is converted into the circular polarized beam, and since the first polarization beam component Lcp and the second polarization beam component Lcs of the circular polarized beam are respectively used with the first and second information storing media D1 and D2, embodiments of the present invention obtain a high optical efficiency. In the conventional optical pickup illustrated in FIG. 1, in the case when the diffraction efficiencies of the 0th order beam 61a and the 1st order beam 64 are set to be the same, the maximum diffraction efficiencies of the 0th order beam 61a and the 1st order beam 64 are respectively 40%, and thus, the intensity of the output beam is only 16 if the input beam has an intensity of 100. However, the first and second polarized beams according to aspects of the present invention both have optical efficiencies of approximately 50%. Thus, the optical pickup according to embodiments of the present invention substantially increases optical efficiency, compared to the conventional optical pickup.

A method of distinguishing between the first and second information storing media D1 and D2 in the optical pickup 200 according to aspects of the present invention will be described as follows. According to an embodiment of the present invention, focusing error signals are detected to distinguish between the first and second information storing media D1 and D2. The times taken to detect the focusing error signals of the first and second information storing media D1 and D2 are different from each other due to the difference between the focal distances and working distances WD1 and WD2 of the first and second information storing media D1 and D2, respectively. In addition, the intensity of the light reflected from a recording surface of an information storage medium D2 having a different standard is higher than that of the light reflected from the surface of the same information storage medium D2. However, the intensity of the light reflected from a recording surface of an information storage medium D2 is weaker than that of the light reflected from the recording surface of the information storage medium D1.

The beam having a focal distance corresponding to the first information storage medium D1 is a first light beam, and the beam having the focal distance corresponding to the second information storage medium D2 is a second light beam. When the first and second light beams are reflected by an information storage medium, a first level signal is generated when the first light beam is reflected by the surface of the information storage medium; a second level signal is generated when the second light beam is reflected by the surface of the information storage medium; a third level signal is generated when the first light beam is reflected by the recording surface of the information storage medium; and a fourth level signal is generated when the second light beam that was reflected by the recording surface of the information storage medium is detected.

Between the third and fourth level signals, due to a reflection of the first and second beams from the recording surface, the signal that is detected when the light is reflected by the recording surface of the corresponding information storage medium is the highest level signal, and the signal detected when the beam is reflected by the recording surface of the information storage medium having a different standard is the second highest level signal. Additionally, the first and second level signals are detected when the beams are reflected from the surfaces of the information storing media, and have similar levels to each other. Therefore, the kinds of first and second information storing media can be determined by using the difference in time between the times of detecting the focusing error signals.

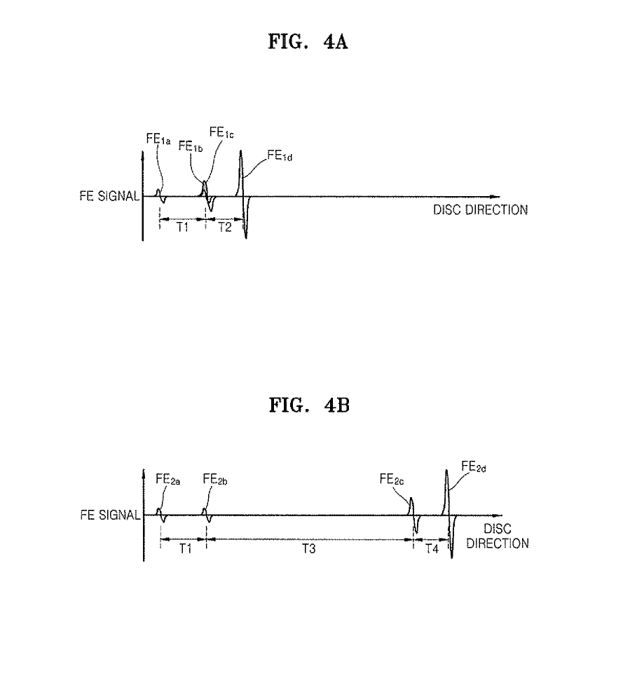

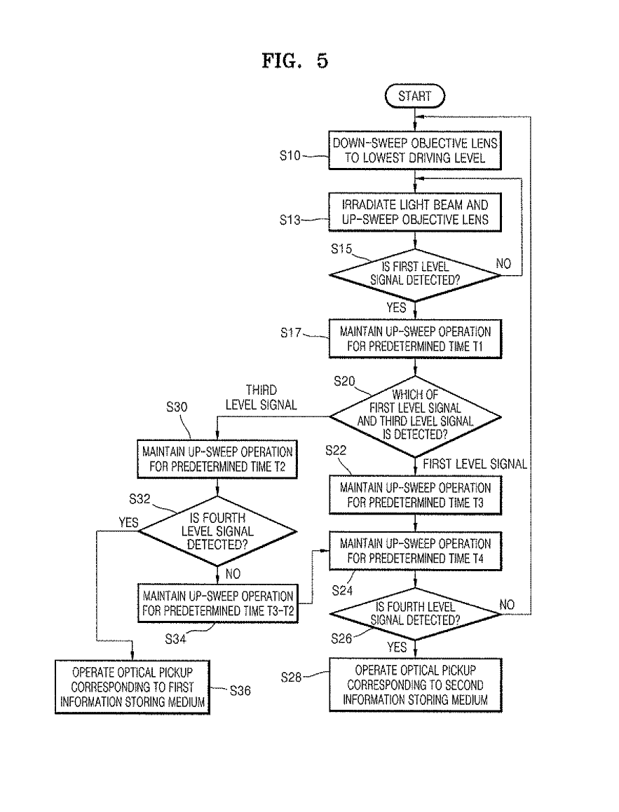

The method of distinguishing the information storage medium will be described in more detail as follows. FIG. 4A is a graph illustrating a focusing signal detected with respect to the first information storage medium D1, according to an embodiment of the present invention. FIG. 4B is a graph illustrating a focusing signal detected with respect to the second information storage medium 92 according to an embodiment of the present invention. FIG. 5 is a flowchart illustrating a method of determining the kind of information storage medium being used by the optical pickup 200 according to an embodiment of the present invention.

Referring to FIG. 4A, FIG. 4B, and FIG. 5, in order to distinguish the type of information storage medium used with the optical pickup 200, the objective lens 115 is initially lowered to the lowest driving level (S10). The objective lens 115 is raised upwards while irradiating the light beam onto the information storage medium until the first level signal is detected (S13). Once the first level signal has been detected (S15), an up-sweeping operation is maintained for a predetermined time T1 (S17). As shown in FIG. 4A, if the information storage medium is the first information storage medium D1, a first signal (FE₁ₐ) that is generated when the second light beam is reflected by the surface of the first information storage medium D1 is detected first, and then, a second signal (FE_{1b}) that is generated when the first light beam is reflected by the surface of the first information storage medium D1 is detected after a predetermined time T1 passes. At the same time, a third signal (FE_{1c}) that is generated when the second light beam is reflected by the recording surface of the first information storage medium D1 is detected. Then, after a predetermined time T2 has passed, a fourth signal (FE_{1d}) that is generated when the first light beam is reflected by the surface of the first information storage medium D1 is detected.

However, if the information storage medium is the second information storage medium D2, a first signal (FE₂ₐ) that is generated when the second light beam is reflected by the surface of the second information storage medium D2 is detected first, and a second signal (FE_{2b}) that is generated when the first light beam is reflected by the surface of the second information storage medium D2 is detected after the predetermined time T1 elapses. Additionally, a third signal (FE_{2c}), that is generated when the first light beam is reflected by the recording surface of the second information storage medium D2, is detected after the predetermined time T2 elapses. Then, a fourth signal (FE_{2d}) that is generated when the second light beam is reflected by the recording surface of the second information storage medium D2 is detected after the predetermined time T3 elapses. Since the second information storage medium D2 is thicker from the surface where light is incident to the recording surface than the thickness from where the surface where light is incident to the recording surface of the first information storage medium D1, a predetermined time T3 of detecting signals is generated when the beams that are reflected by the recording surface of the second information storage medium D2 take longer to reflect back to the photodetector 125 than the signals reflected by the first information storage medium D1.

From among the above mentioned signals, FE₁ₐ, and FE₂ₐ are the first level signals for D1 and D2, respectively, and FE_{1b} and FE_{2b} are the second level signals for D1 and D2, respectively. These first and second level signals FE₁ₐ, FE_{1b}, FE₂ₐ, and FE_{2b} have similar levels to each other so that they cannot be distinguished from each other easily. However, the first level signal FE₁ₐ, FE₂ₐ and the third level signal FE_{1c}, FE_{2c} can be distinguished from each other easily. Thus, the optical pickup 200 can determine whether the first level signal FE₁ₐ, FE₂ₐ or the third level signal FE_{1c}, FE_{2c} is detected after the predetermined time T1 passes (S20). In the case where the third level signal FE_{1c}, FE_{2c} is detected, the up-sweeping operation is maintained for the predetermined time T2 (S30). In the case where the first level signal FE₁ₐ, FE₂ₐ (which is similar in magnitude to the second level signal FE_{1b}, FE_{2b}) is detected, the up-sweeping operation is maintained for the predetermined time T3 (S22). Then, after performing operation S22, the objective lens 115 is up-swept until the fourth level signal FE_{2d} is detected (S24 and S26). When the fourth level signal FE_{2d} has been detected, the information storage medium is determined to be the second information storage medium D2, and the optical pickup 200 operates corresponding to the standards of the second information storage medium D2.

Additionally, if the fourth level signal FE_{1d} is detected as determined in operation S30, the information storage medium is determined to be the first information storage medium D1, and the optical pickup 200 operates corresponding to the standards of the first information storage medium D1. If the fourth level signal FE_{1d} is not detected as determined in operation S30, the objective lens 115 is up-swept for a predetermined time measured as T3−T2(S34)+T4 (S24) in order to detect the fourth level signal FE_{2d}. Then, if the fourth level signal FE_{2d} has been detected, the information storage medium is determined to be the second information storage medium D2. The above described method is performed to determine the kind of the information storing media based on the fact that the times required to detect the fourth level signals of the beams reflected by the recording surfaces of the corresponding information storing media are different from each other according to the kind of information storing media.

After the optical pickup 200 determines which kind of information storage medium is being used, the working distances WD1 and WD2 between the information storage medium and the objective lens 115 are adjusted by the optical pickup 200 to correspond to the information storage medium. The optical pickup 200 may then perform optical recording and/or reproducing operations according to the standards of the information storage medium.

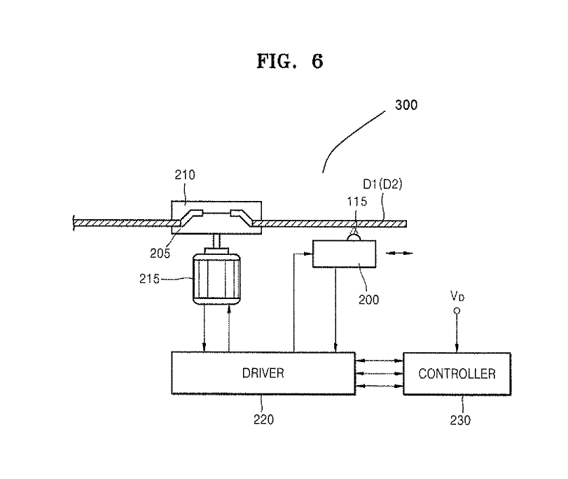

FIG. 6 is a schematic block diagram of an optical recording and/or reproducing apparatus 300 including the optical pickup 200, according to an embodiment of the present invention. Referring to FIG. 6, an optical recording and/or reproducing apparatus 300 according to an embodiment of the present invention includes a spindle motor 215 installed under a turntable 205 for rotating the first and second information storing media D1 and D2, a turntable 205 for mounting the first and second information storage medium D1 and D2, respectively, and a clamp 210 facing the turntable 205 which clamps to the information storing media D1 and D2 using an electromagnetic force generated by an interaction with the turntable 205. It is understood that the optical recording and/or reproducing apparatus 300 may include many other components instead of or in addition to the spindle motor 215, the turntable 205 and the clamp 210. It is further understood that the motor 215 used with the optical recording and/or reproducing apparatus 300 does not have to be a spindle motor, and that the clamp 210 does not have to use an electromagnetic force to clamp the first and second information storage medium D1 or D2, respectively, into place.

When the information storage medium D1 or D2 is rotated by the spindle motor 215, the optical pickup 200 can move in a radial direction with respect to the information storage medium D1 or D2 in order to reproduce the information recorded on the information storage medium D1 or D2 and/or to record information on the information storage medium D1 or D2. The information storing media may be various kinds of media having different track pitches and/or different thicknesses. However, the optical recording and/or reproducing apparatus 300 uses one light source 100 and one objective lens 115.

The spindle motor 215 and the optical pickup 200 are driven by a driving unit 220 and a controller 230 that controls a focusing servo and a tracking servo of the optical pickup 200 in order to perform the recording and/or reproducing of the data onto and/or from the information storing media. The driving unit 220 may include many different types of motors, such as, for example, an electric motor, and the controller 230 may be various types, such as a wired controller, a wireless controller, etc.

The optical pickup 200 used with the optical recording and/or reproducing apparatus 300 preferably has the structure as illustrated in FIGS. 3A and 3B. The signals detected and photoelectrically converted by the optical pickup 200 are input to the controller 230 through the driving unit 220. The driving unit 220 controls the rotating speed of the spindle motor 215, amplifies the input signals, and drives the optical pickup 200.

The controller 230 transmits a focusing servo command and a tracking servo command to the driving unit 220. The focusing servo command and the tracking servo command are adjusted based on the signal input from the driving unit 220, in order to control the focusing servo and the tracking servo. The optical recording and/or reproducing apparatus 300 compensates for the spherical aberration generated due to the information storing media having different standards by using the holographic optical element 110 and the objective lens 115 of the optical pickup 200. The controller 230 controls the focusing and tracking of the different kinds of information storing media that compatibly use the detected signal by reflecting the beam onto the information storing media.

As described above, the optical pickup 200 according to embodiments of the present invention uses one light source 100 and one objective lens 115, and thus can be compatibly used with respect to information storing media having different standards, thereby increasing optical efficiency during recording and/or reproducing operations. Furthermore, aspects of the optical pickup 200 can be compatibly used with information storage media which have different standards using only one objective lens and a plurality of optical elements. In addition, since there is no need to compensate for the optical axis, the optical system can be simplified. Also, the holographic optical element 110 having different diffraction properties according to the polarization of the incident light is used to compensate for the spherical aberration that is generated due to the difference in the standards between the information storing media. By compensating for spherical aberration, the holographic optical element 110 thereby increases optical efficiency during recording and/or reproducing operations

While not required in all aspects, aspects of the invention can be implemented using a computer program encoded on a medium readable by a computer. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical pickup that is compatibly used with respect to a first information storage medium and a second information storage medium having different standards, the optical pickup comprising:
a light source to emit a light beam;
a polarization beam splitter to transmit or reflect the light beam according to a polarization direction of the light beam;
a quarter wave plate to change the polarization direction of the light beam that passes through the polarization beam splitter;
a holographic optical element formed of an anisotropic material and comprising a diffraction pattern to directly transmit and diverge the light beam that passes through the quarter wave plate according to the polarization direction of the light beam; and
an objective lens to focus a first polarized beam component that is transmitted directly through the holographic optical element onto the first information storage medium with a first numerical aperture (NA), and to focus a second polarized beam component that is diverged by the holographic optical element onto the second information storage medium with a second NA.

2. The optical pickup of claim 1, wherein the holographic optical element diffracts the second polarized beam component in a diffraction of single order.

3. The optical pickup of claim 2, wherein the second polarized beam component is diffracted as a +1st order beam.

4. The optical pickup of claim 1, wherein the holographic optical element has a blazed type holographic pattern.

5. The optical pickup of claim 1, wherein the first and second information storing media have different thicknesses.

6. The optical pickup of claim 5, wherein the thickness of the first information storage medium is 0.1 mm, and the thickness of the second information storage medium is 0.6 mm.

7. The optical pickup of claim 1, further comprising:
a collimating lens disposed between the light source and the polarization beam splitter.

8. An optical recording and/or reproducing apparatus comprising:
an optical pickup to compatibly operate with a first information storage medium and a second information storage medium that have different standards;
a driving unit to drive the optical pickup; and
a controller to control the optical pickup,
wherein the optical pickup comprises:
a light source to emit a light beam,
a polarization beam splitter to transmit or reflect the light beam according to a polarization direction of the light beam,
a quarter wave plate to change the polarization direction of the light beam that passes through the polarization beam splitter,
a holographic optical element formed of an anisotropic material and comprising a diffraction pattern to transmit and diverge the light beam that passes through the quarter wave plate according to the polarization direction of the light beam, and
an objective lens to focus a first polarized beam component that is transmitted directly through the holographic optical element onto the first information storage medium with a first numerical aperture (NA), and to focus a second polarized beam that is diverged by the holographic optical element onto the second information storage medium with a second NA.

9. The apparatus of claim 8, wherein the holographic optical element diffracts the second polarized beam component in a diffraction of single order.

10. The apparatus of claim 9, wherein the second polarized beam component is diffracted as a +1 st order beam.

11. The apparatus of claim 8, wherein the holographic optical element has a blazed type holographic pattern.

12. The apparatus of claim 8, wherein the first and second information storing media have different thicknesses.

13. The apparatus of claim 12, wherein the thickness of the first information storage medium is 0.1 mm, and the thickness of the second information storage medium is 0.6 mm.

14. The apparatus of claim 8, further comprising:
a collimating lens disposed between the light source and the polarization beam splitter.

15. An optical pickup that is compatibly used with respect to information storage media having different standards, the optical pickup comprising:
a light source to emit a light beam which is polarized into a first polarization beam component and a second polarization beam component;
a holographic optical element formed of an anisotropic material and comprising a diffraction pattern which transmits the first polarization beam component and diffracts the second polarization beam component; and
an objective lens to focus the transmitted first polarized beam component onto a recording layer of a first information storage media and a second polarization beam component onto a recording layer of a second information storage media.

16. The optical pickup of claim 15, wherein the optical pickup further comprises:
a collimating lens to focus the emitted light beam to be parallel; and
a quarter wave plate to circular polarize the collimated light beams into the first polarization beam component and the second polarization beam component.

17. An optical recording and/or reproducing apparatus which can distinguish a type of an information storage medium among first and second information storage media having different thicknesses, comprising:
an optical pickup having an objective lens to focus first and second polarization beam components onto recording layers of each of the information storage media;
a driving unit to drive the optical pickup; and
a controller to control the optical pickup,
wherein the optical pickup distinguishes the type of the information storage media by lowering the objective lens to a lowest driving level, irradiating a light beam onto the information storage medium while moving the objective lens with respect to the information storage medium, and detecting focusing error signals to distinguish between the first and the second information storage media using predetermined times taken to detect the focusing error signals of the first and the second information storing media, which are different from each other due to differences in thicknesses of the first and second information storage media.

18. The optical recording and/or reproducing apparatus of claim 17, where the optical pickup comprises:
a light source to emit a light beam which is polarized into the first polarization beam component and the second polarization beam component; and
a holographic optical element formed of an anisotropic material and comprising a diffraction pattern.
